(19) United States
(12) Patent Application Publication
(10) Pub. No.: US 2022/0145737 A1
(43) Pub. Date: May 12, 2022

(54) THRU-TUBING CONVEYED PUMP SYSTEM HAVING A CROSSOVER COUPLING WITH POLYGONAL COUPLING MEMBERS

(71) Applicant: Halliburton Energy Services, Inc., Houston, TX (US)

(72) Inventors: Casey Laine NEWPORT, Tulsa, OK (US); Josh Wayne WEBSTER, Sand Springs, OK (US); Steven Andrew LOVELL, Tulsa, OK (US); Wesley NOWITZKI, Tulsa, OK (US)

(21) Appl. No.: 17/096,324

(22) Filed: Nov. 12, 2020

(51) Int. Cl. E21B 43/12; E21B 23/14; F04D 13/10

(52) U.S. Cl. CPC E21B 43/128; F04D 13/10; E21B 23/14

(57) ABSTRACT

A thru-tubing conveyed (TTC) pump system comprising a rig-deployed assembly and a TTC removable assembly. The rig-deployed assembly includes a motor and a receiving base. The motor is configured to turn a first shaft, and an end of the first shaft includes a non-circular cross-section in a plane perpendicular to a longitudinal axis of the first shaft. The TTC removable assembly includes an engaging base and a pump, the pump configured to be turned by a second shaft. An end of the second shaft has a non-circular cross-section in a plane perpendicular to a longitudinal axis of the second shaft. The engaging base of the TTC removable assembly engages the receiving base of the rig-deployed assembly when the TTC removable assembly is delivered downhole.

### BACKGROUND

The present disclosure relates generally to a thru-tubing conveyed, electric submersible pump system used within a subterranean well, and more specifically to a systems, apparatuses and method employing a crossover coupling having polygonal coupling members to allow selective engagement of the pump and motor.

Thru-tubing conveyed (TTC), electric submersible pump (ESP) systems may be used in wells located in remote areas such as the North Slope. The high costs and increased time required for workovers in such wells requires economical and fast ways to replace the consumable components of the TTC removable pump assembly. The consumables are primarily associated with the ESP, while motor used to drive the ESP is capable of operating for a much longer time without being serviced or replaced. By allowing separation of the ESP and motor downhole, the ESP may pulled from the well and replaced using slickline or coiled tubing. Since the motor, tubing, seals and power supply line are left in the well, the pump is capable of being replaced as needed without killing or working over the well.

### BRIEF DESCRIPTION OF THE DRAWINGS

FIG. 1 illustrates a schematic view of a thru-tubing conveyed (TTC) pump system according to an illustrative embodiment;

FIG. 2 illustrates a schematic view of a rig-deployed assembly of a TTC pump system according to an illustrative embodiment;

FIG. 3 illustrates a schematic view of TTC removable assembly of a TTC pump system according to an illustrative embodiment;

FIG. 4 illustrates a schematic view of a TTC pump system, the system having a crossover coupling according to an illustrative embodiment;

FIG. 5 illustrates an isometric view of a first shaft and a first coupling member of the TTC pump system of FIG. 4;

FIG. 6 illustrates an isometric view of a second shaft and a second coupling member of the TTC pump system of FIG. 4;

FIG. 7 illustrates a cross-sectional view of the engaged first and second shafts of the TTC pump system of FIG. 4 taken at 7-7, the first and second shafts having polygonal coupling members according to an illustrative embodiment;

FIG. 8 illustrates a cross-sectional view of a coupling member of a TTC pump system, the coupling member having a polygonal profile according to an illustrative embodiment; and

FIG. 9 illustrates a cross-sectional view of a coupling member of a TTC pump system, the coupling member having a polygonal profile according to an illustrative embodiment.

### DETAILED DESCRIPTION

In the following detailed description of several illustrative embodiments, reference is made to the accompanying drawings that form a part hereof. These embodiments are described in sufficient detail to enable those skilled in the art to practice the disclosed subject matter, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments is defined only by the appended claims.

Unless otherwise specified, any use of any form of the terms “connect,” “engage,” “couple,” “attach,” or any other term describing an interaction between elements is not meant to limit the interaction to direct interaction between the elements and may also include indirect interaction between the elements described. In the following discussion and in the claims, the terms “including” and “comprising” are used in an open-ended fashion, and thus should be interpreted to mean “including, but not limited to”. Unless otherwise indicated, as used throughout this document, “or” does not require mutual exclusivity.

As used herein, the phrases “hydraulically coupled,” “hydraulically connected,” “in hydraulic communication,” “fluidly coupled,” “fluidly connected,” and “in fluid communication” refer to a form of coupling, connection, or communication related to fluids, and the corresponding flows or pressures associated with these fluids. In some embodiments, a hydraulic coupling, connection, or communication between two components describes components that are associated in such a way that fluid pressure may be transmitted between or among the components. Reference to a fluid coupling, connection, or communication between two components describes components that are associated in such a way that a fluid can flow between or among the components. Hydraulically coupled, connected, or communicating components may include certain arrangements where fluid does not flow between the components, but fluid pressure may nonetheless be transmitted such as via a diaphragm or piston or other means of converting applied flow or pressure to mechanical or fluid force.

The present disclosure relates to a thru-tubing conveyed (TTC) pump system that includes a pump operatively coupled to and driven by a motor. The motor and the pump are connected by way of a crossover coupling. The crossover coupling allows selective engagement or separation of a rig-deployed assembly and a removable pump assembly of the TTC pump system. The rig-deployed assembly includes the motor and is meant to remain in the wellbore even if the removable pump assembly is removed to replace the pump. The crossover coupling includes a first and second portion, which may also be referred to as a receiving base and an engaging base. The engaging base is disposed at an end of the rig-deployed assembly, while the receiving base is disposed at an end of the removable pump assembly. The TTC pump system further includes engageable shafts that each include a coupling member configured to matingly engage the coupling member on the other shaft. The engagement between coupling members allows power transmission between the two shafts, which therefore allows power transmission between the motor and the pump.

The coupling member of one shaft has a non-circular cross-section and is received by a coupling member on the other shaft that also has a non-circular cross-section. Since both coupling members have complimentary non-circular cross-sections, the coupling members are capable of transferring rotational power without the use of splines, keys and keyways, or other fastener-related coupling members that are often used to couple power transmission components.

The coupling members are removably coupled such that one shaft may be disengaged from the other while downhole in a wellbore to allow removal of the removable pump assembly while allowing the rig-deployed assembly to remain in the wellbore. Similar to the decoupling of the shafts, the engaging base may be disengaged from the receiving base during removal of the removable pump assembly. Removal of the removable pump assembly allows replacement of the pump or other consumables such as seals and impellers that require more frequent replacement than components of the motor. The ability to remove only the removable pump assembly from the well eliminates the need to kill and workover the well, thereby reducing the frequent need for large rigs and other equipment in remote well locations.

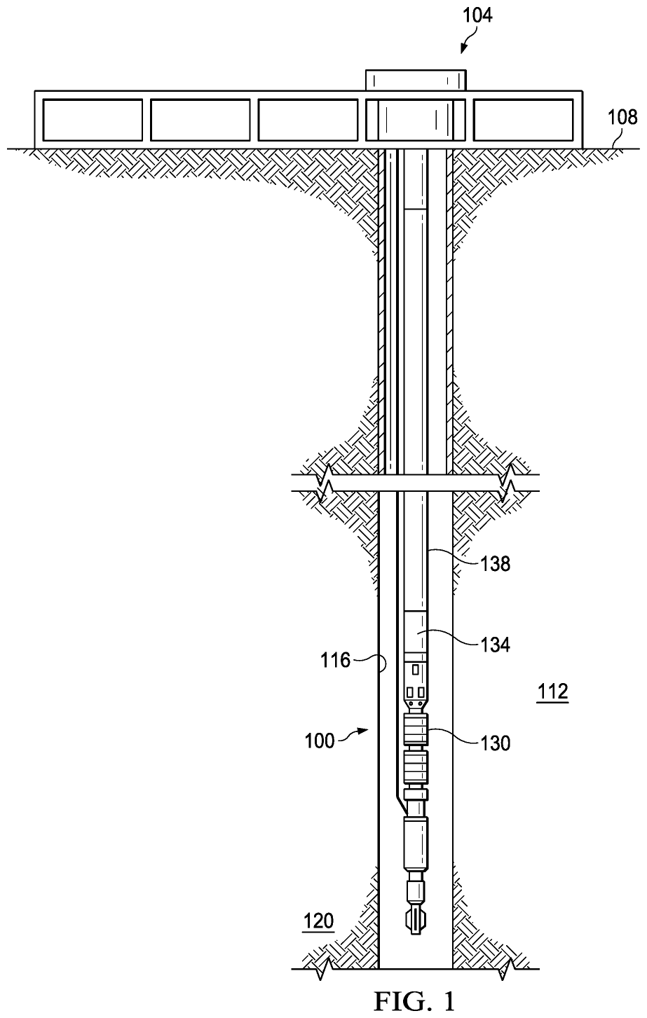

FIG. 1 illustrates a platform 104 positioned at a surface 108 of a well 112 to operate a TTC pump system 100 according to an illustrative embodiment. The well 112 includes a wellbore 116 that extends from the surface 108 of the well 112 to a subterranean substrate or formation 120. The well 112 and platform 104 are illustrated onshore in FIG. 1; although the platform could instead be configured to be positioned above an off-shore well. In such a configuration, the TTC pump system 100 may be deployed in the sub-sea well accessed by an offshore platform (not shown). The offshore platform may be a floating or platform or may instead be anchored to a seabed.

While the following description of the TTC pump system 100 primarily focusses on the use of the TTC pump system 100 during the production stage of the well 112, the TTC pump system 100 also may be used in other stages of the well 112 where it may be desired to remove fluids from the wellbore 116.

The TTC pump system 100 is particularly suited for use in wells that require liquid removal and are located in remote areas. The TTC pump system 100 includes a rig-deployed assembly 130 and a removable pump assembly 134. As described in more detail below, the rig-deployed assembly 130 and the removable pump assembly 134 are selectively engageable or separable to allow removal of the removable pump assembly 134 from the well. Removal of the removable pump assembly 134 allows consumable components of the TTC pump system 100 to be replaced while allowing the rig-deployed assembly 130 to remain in the wellbore 116. By allowing the rig-deployed assembly 130 to remain in the well, it is no longer required to completely kill and workover the well to replace the consumable components of the removable pump assembly 134.

A tubing string 138 extends from the surface of the well downhole and is coupled to a portion of the rig-deployed assembly 130. The rig-deployed assembly 130 may initially be deployed downhole coupled to the tubing string 138. The tubing string 138 serves as a delivery conduit for the removable pump assembly and guides the removable pump assembly downhole and into engagement with the rig-deployed system.

The removable pump assembly 134 may be engaged to or disengaged from the rig-deployed assembly using a slickline or coiled tubing. While a slickline or coiled tubing rig is not illustrated, the cost of deploying such a rig is less costly and faster than the rigging equipment needed to workover the well 112.

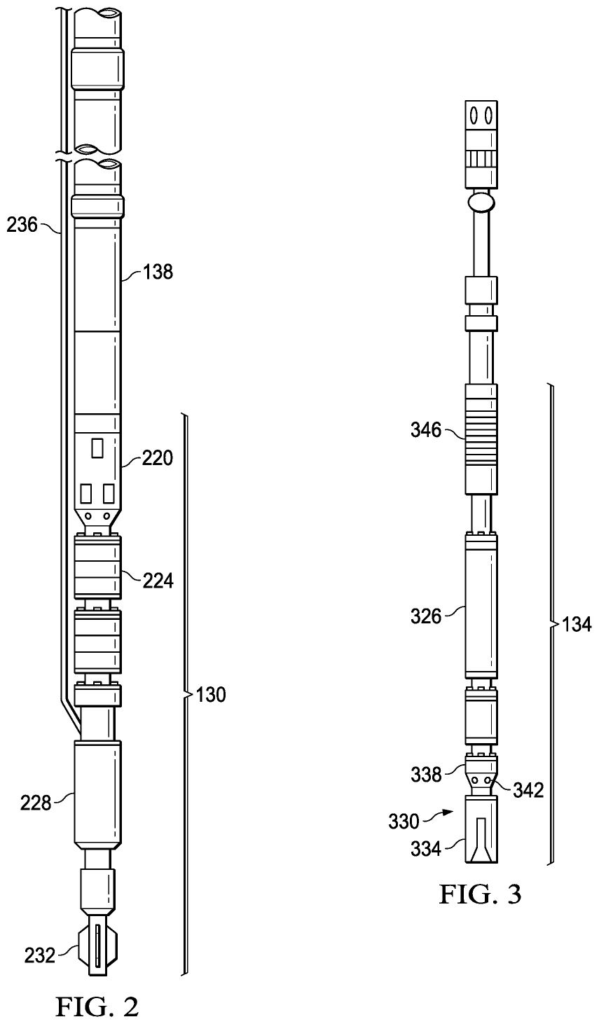

FIG. 2 illustrates a schematic view of the rig-deployed assembly 130 and is shown coupled to the tubing string 138. The rig-deployed assembly 130 includes a crossover, or receiving base 220, a seal assembly 224, and a motor 228 coupled together such that the receiving base 220 is at an uphole end of the rig-deployed assembly 130. The seal assembly 224 is preferably positioned between the receiving base 220 and the motor 228. The rig-deployed assembly 130 may also include a centralizer 232 disposed below the motor 228 to center the rig-deployed assembly 130 in the wellbore 116. A power supply line or cable 236 is coupled to an exterior of the tubing string 138 and runs to the surface of the well 112. The power supply line 236 is capable of providing electrical power to the motor 228. Preferably the power supply line 236 is armored for protection against the harsh atmosphere of the wellbore 116.

FIG. 3 illustrates a schematic view of the removable pump assembly 134, which may be coupled to a slickline or coiled tubing for deployment through the tubing string 138 and into engagement with the rig-deployed assembly 130. The removable pump assembly 134 includes a pump 326 and an engaging base 334 that is configured to land in the receiving base 220 as explained in more detail below. An intake housing 338 is coupled to the engaging base 334, and the intake housing 338 includes a plurality of perforations 342, or slots, to allow communication with an impeller of the pump 326. Located uphole of the pump 326 is a centralizer 346 that may be used to center the removable pump assembly 134 as it is lowered or raised through the tubing string 138. The centralizer 346 may be a bow spring centralizer or any other suitable centralizing device.

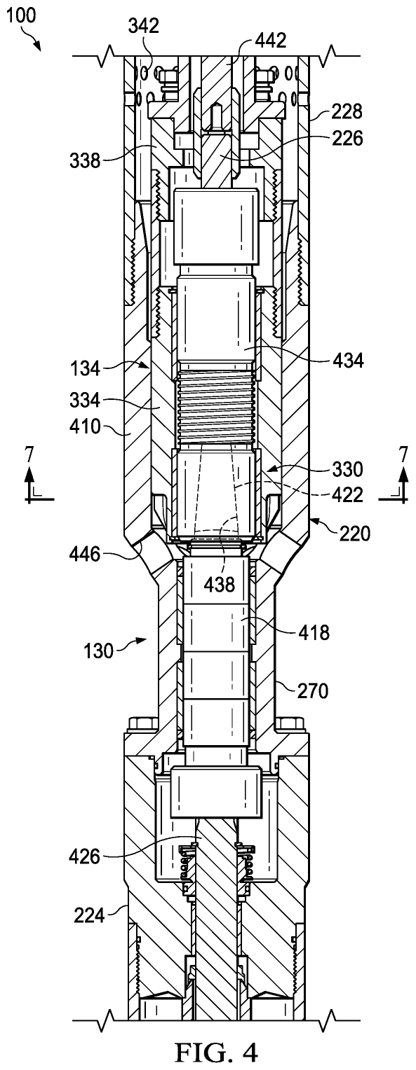

FIG. 4 illustrates a schematic cross-sectional view of the removable pump assembly 134 coupled to the rig-deployed assembly 130. The engaging base 334 is configured to land within receiving base 220. The mating engagement between the engaging base 334 and the receiving base 220 form a crossover coupling, or mated assembly, between the rig-deployed assembly 130 and the removable pump assembly 134. While the engaging base 334 being received by the receiving base 220 provides structural rigidity and coupling between the two assemblies, the crossover coupling also provides for the coupling of two shafts that together transmit power from the motor 228 to the pump 326 (not shown in FIG. 4). A first shaft 418 is operably coupled to the motor 228 and has a first coupling member 422 at an uphole end of the first shaft 418. While the first shaft 418 may be a single shaft that extends from the first coupling member 422 to the motor 228 (not shown in FIG. 4), it is also possible that that multiple shafts may be coupled together between the first coupling member 422 and the motor 228. An example of this is illustrated in FIG. 4, where the first shaft 418 is positioned with the receiving base 220 and is a coupled to a motor seal shaft 426 in the seal assembly 224. The motor seal shaft 426 may in turn be coupled to a motor output shaft (not shown) that is turned directly by the motor 228.

A second shaft 434 is disposed within the engaging base 334. The second shaft 434 is operably coupled to the pump 326 and has a second coupling member 438 at a downhole end of the second shaft 434. While the second shaft 434, similar to the first shaft 418, may be a single shaft that extends from the second coupling member 438 to the pump 326 (not shown in FIG. 4), it is also possible that multiple shafts may be coupled together between the second coupling member 438 and the pump 326. An example of this is illustrated in FIG. 4, where the second shaft 434 is positioned with the engaging base 334 and is a coupled to an intake shaft 442 that is coupled to the impellers (not shown) of the pump 326.

The first coupling member 422 and the second coupling member 438 are capable of mating engagement to allow power transmission between the first shaft 418 and the second shaft 434, which thereby allows rotation to be transmitted by the motor 228 to the pump 326. The first coupling member 422 is illustrated in FIG. 4 as a male-type coupling member, while the second coupling member 422 is a female-type coupling member. In other embodiments, the male-female orientation may be reversed such that the first coupling member 422 is the female-type coupling member, while the second coupling member 422 is the male-type coupling member. Both of the coupling members are shown as having a tapered configuration, which assists in initially guiding and landing the coupling members together. The tapered arrangement also allows for a more secure connection between the first and second shafts 418, 434. As described in more detail below, the first and second coupling members 422, 438 are each non-circular in cross-section, which is responsible for ensuring efficient power transfer between the first and second shafts 418, 434.

The receiving base 220 also includes a plurality of perforations 446 on the receiving base 410, which allows fluid communication between the outside the receiving base 220 and an interior of the receiving base 220. An annulus between the receiving base 220 and the wellbore 116 may include water or other liquids that are desired to be removed from the well 112. The water is capable of being drawn through the perforations 446 on the receiving base 220 and into the tubing string 138. The plurality of perforations 342 on the intake housing 338 (FIG. 3) of the removable pump assembly 134 allow fluid inside the tubing string 138 to be communicated to the impeller of the pump 326, which allows the fluid to be pumped from the well 112.

Various types of water, hydrocarbons, or other liquids may be pumped to the surface location 108 by the pump 326. The pump 326 may be an electric submersible pump (ESP), or other pumps may instead be substituted for the ESP. For example, in some embodiments, the pump may be an electric submersible progressive cavity pump (ESPCP). In such a configuration, the motor may still be used to transmit rotational power through the crossover coupling to the ESPCP.

FIG. 5 illustrates an isometric view of the first shaft 418 and the first coupling member 422 of the TTC pump system 100. The first shaft 418 may include an intermediate coupling member 512 at an end of the first shaft 418 opposite the first coupling member 422. The intermediate coupling member 512 may have a splined interior to mate with a similarly splined coupling on an adjacent shaft. At least one bearing sleeve 516 may be disposed on the first shaft 418 to act as bushings or bearing surfaces for bearings that support the first shaft 418. In some embodiments, the bearing sleeves 516 may not be included, and a surface of the first shaft 418 itself may contact bushings or bearings positioned adjacent the first shaft 418.

As mentioned previously, the first coupling member 422 of the first shaft 418 includes a non-circular cross-section in a plane normal to a longitudinal axis 520 of the first shaft 418. In the embodiment illustrated in FIG. 5, the first coupling member 422 is a polygonal shape.

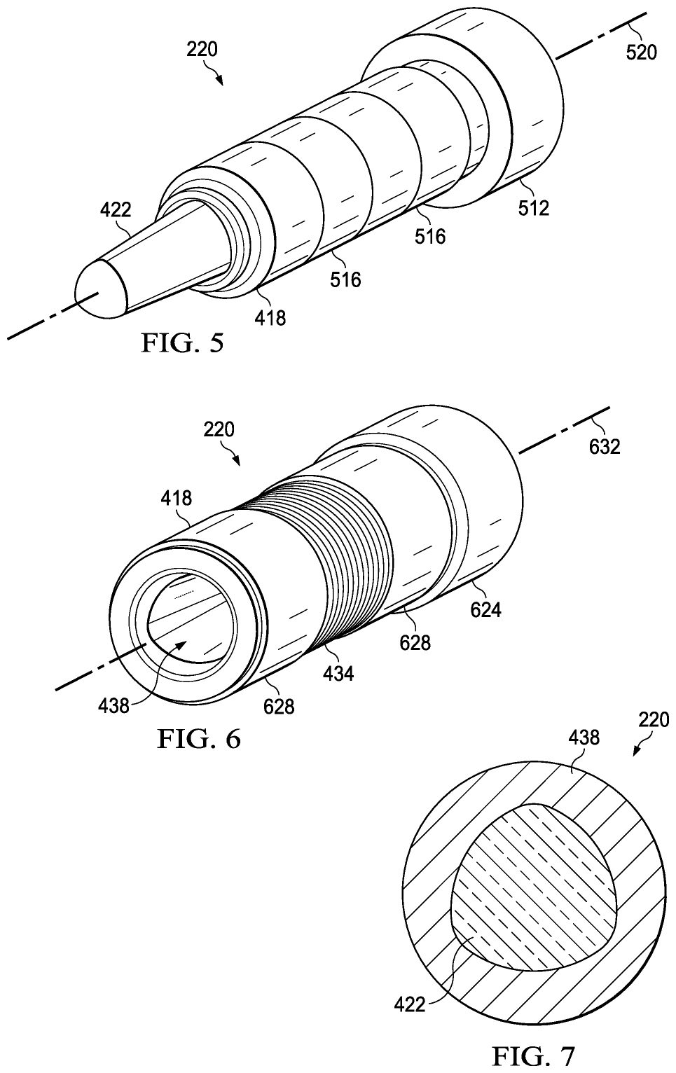

FIG. 6 illustrates an isometric view of the second shaft 434 and the second coupling member 438 of the TTC pump system 100. The second shaft 434 may include an intermediate coupling member 624 at an end of the second shaft 434 opposite the second coupling member 438. The intermediate coupling member 624 may have a splined interior to mate with a similarly splined coupling on an adjacent shaft. At least one bearing sleeve 628 may be disposed on the second shaft 434 to act as bushings or bearing surfaces for bearings that support the second shaft 434. In other embodiments, the bearing sleeve 628 may be omitted such that an exterior surface of the shaft 434 directly contacts bearings or bushings positioned adjacent the second shaft 434.

As mentioned previously, the second coupling member 438 of the second shaft 434 includes a non-circular cross-section in a plane normal to a longitudinal axis 632 of the second shaft 434. In the embodiment illustrated in FIG. 6, the second coupling member 438 is a polygonal shape. The polygonal shape of the first and second coupling member 422, 438 differs from current designs that employ splines to transfer power between coupling members. Splined connections are more difficult to mate together downhole and in some cases result in damage to the coupling members, especially when the shafts are repeatedly engaged and disengaged. Tapered, non-circular coupling members, on the other hand, allow for an easier and less damaging process of coupling the two power transmission shafts.

FIG. 7 illustrates a cross-sectional view of the first and second shafts 418, 434 of the TTC pump system 100 of FIG. 4 taken at 7-7. The shaft 418, 434 include the polygonal first coupling member 422 and the second coupling member 438. As shown, the first and second coupling members 422, 438 mate closely together which enables efficient power transmission between the coupling members.

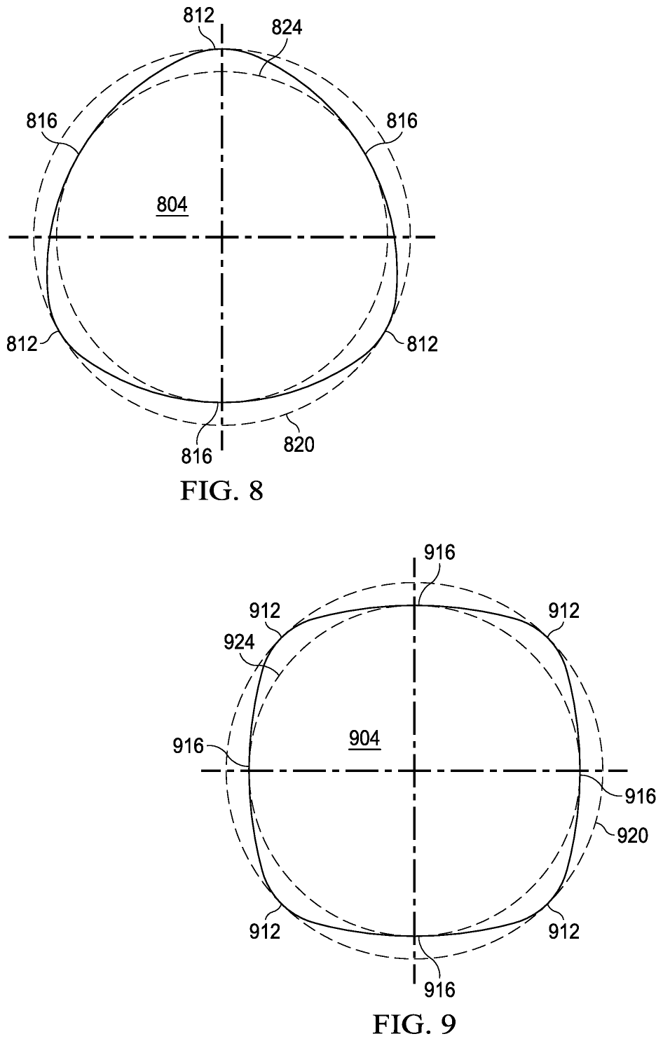

FIG. 8 illustrates a cross-sectional view of a coupling member 804 of a TTC pump system according to an illustrative embodiment. The coupling member 804 has a polygonal cross-sectional shape. The coupling member 804 is similar in shape to the non-circular shape of the coupling members 422, 438 illustrated in FIGS. 5 and 6 and includes a plurality of lobes 812. More specifically, the coupling member 804 includes three lobes 812, each lobe 812 being disposed about 120 degrees from an adjacent lobe 812. The coupling member 804 further comprises three flats 816, each flat 816 disposed about 120 degrees from an adjacent flat 816 and positioned between two of the three lobes 812. The arrangement of the lobes 812 and flats 816 is such that a first circle 820 that circumscribes the lobes 812 is concentric to a second circle 824 that circumscribes the flats 816.

FIG. 9 illustrates a cross-sectional view of a coupling member 904 of a TTC pump system according to an illustrative embodiment. The coupling member 904 has a polygonal cross-section shape. The coupling member 904 includes four lobes 912, each lobe 912 being disposed about 90 degrees from an adjacent lobe 912. The coupling member 904 further comprises four flats 916, each flat 916 disposed about 90 degrees from an adjacent flat 916 and positioned between two of the lobes 912. The arrangement of the lobes 912 and flats 916 is such that a first circle 920 that circumscribes the lobes 912 is concentric to a second circle 924 that circumscribes the flats 916.

The three- and four-lobed coupling members 804, 904 illustrated in FIGS. 8 and 9 are examples of non-circular cross-sections that may be used to transmit power within the crossover coupling between the motor and the pump. Other non-circular cross-sections are possible, including cross-sections that include two lobed configurations or configurations with more than four lobes. In an embodiment, the configuration of the cross-section is such that rotation of the couplings members and shafts is balanced and does not create excessive vibration.

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. The scope of the claims is intended to broadly cover the disclosed embodiments and any such modification. Further, the following clauses represent additional embodiments of the disclosure and should be considered within the scope of the disclosure:

Clause 1, a thru-tubing conveyed (TTC) pump system comprising a rig-deployed assembly having a motor and a receiving base, the motor configured to turn a first shaft, an end of the first shaft having a non-circular cross-section in a plane perpendicular to a longitudinal axis of the first shaft; a TTC removable assembly having an engaging base and a pump, the pump configured to be turned by a second shaft, an end of the second shaft having a non-circular cross-section in a plane perpendicular to a longitudinal axis of the second shaft; wherein the engaging base of the TTC removable assembly engages the receiving base of the rig-deployed assembly when the TTC removable assembly is delivered downhole.

Clause 2, the downhole centrifugal pump of clause 1, wherein the end of the first shaft and the end of the second shaft are matingly engaged such that the first shaft and second shaft transmit power from the motor to the pump.

Clause 3, the downhole centrifugal pump of clause 2, wherein the engaging base and the receiving base are configured to be de-coupled such that the TTC removable assembly is removed from the well.

Clause 4, the downhole centrifugal pump of any of clauses 1-3, wherein the non-circular cross-section of the coupling members is polygonal.

Clause 5, the downhole centrifugal pump of any of clauses 1-4, wherein the non-circular cross-section of the coupling members further comprises a plurality of lobes.

Clause 6, the downhole centrifugal pump of any of clauses 1-5, wherein the non-circular cross-section of the coupling members further comprises three lobes, each lobe being disposed about 120 degrees from an adjacent lobe.

Clause 7, the downhole centrifugal pump of clause 6, wherein the non-circular cross-section of the coupling members further comprises three flats, each flat disposed about 120 degrees from an adjacent flat and positioned between two of the three lobes.

Clause 8, the downhole centrifugal pump of clause 7, wherein a first circle that circumscribes the lobes is concentric to a second a circle that circumscribes the flats.

Clause 9, the downhole centrifugal pump of any of clauses 1-8, wherein the non-circular cross-section of the coupling members further comprises four lobes, each lobe being disposed about 90 degrees from an adjacent lobe.

Clause 10, a crossover coupling for a thru-tubing conveyed (TTC) pump system comprising an engaging base and a first shaft having a longitudinal axis, the first shaft having a first coupling member with a non-circular cross-section in a plane perpendicular to the longitudinal axis; a receiving base and a second shaft having a longitudinal axis, the second shaft having a second coupling member with a non-circular cross-section in a plane perpendicular to the longitudinal axis; wherein the engaging base is configured to be removably coupled to the receiving base.

Clause 11, the crossover coupling of clause 10, wherein the first coupling member of the first shaft matingly engages the second coupling member of the second shaft to transmit power between the first shaft and the second shaft.

Clause 12, the crossover coupling of clause 11, wherein the first shaft is removably coupled to the second shaft.

Clause 13, the crossover coupling of any of clauses 10-12, wherein the non-circular cross-section of the coupling members is polygonal.

Clause 14, the crossover coupling of clause any of clauses 10-13, wherein the non-circular cross-section of the coupling members further comprises a plurality of lobes.

Clause 15, the crossover coupling any of clauses 10-14, wherein the non-circular cross-section of the coupling members further comprises three lobes, each lobe being disposed about 120 degrees from an adjacent lobe.

Clause 16, the crossover coupling of clause 15, wherein the non-circular cross-section of the coupling members further comprises three flats, each flat disposed about 120 degrees from an adjacent flat and positioned between two of the three lobes.

Clause 17, the crossover coupling of clause 16, wherein a first circle that circumscribes the lobes is concentric to a second a circle that circumscribes the flats.

Clause 18, the crossover coupling of any of clauses 10-17, wherein the non-circular cross-section of the coupling members further comprises four lobes, each lobe being disposed about 90 degrees from an adjacent lobe.

Clause 19, a method of removing fluid from a wellbore comprising within a crossover coupling of a thru-tubing conveyed (TTC) pump system, rotating about a longitudinal axis a first shaft and a second shaft, the first shaft coupled to a motor, the second shaft coupled to a pump; wherein the first shaft and the second shaft are coupled by mating coupling members, each coupling member having a non-circular cross-section in a plane perpendicular to the longitudinal axis.

Clause 20, the method of clause 19 further comprising uncoupling the first and second shafts while located downhole to allow removal of the pump from the wellbore.

While this specification provides specific details related to certain components of a TTC pump system and method, it may be appreciated that the list of components is illustrative only and is not intended to be exhaustive or limited to the forms disclosed. Other components related to downhole pumps within a wellbore or TTC pump systems will be apparent to those of ordinary skill in the art without departing from the scope and spirit of the disclosure. Further, the scope of the claims is intended to broadly cover the disclosed components and any such components that are apparent to those of ordinary skill in the art.

It should be apparent from the foregoing disclosure of illustrative embodiments that significant advantages have been provided. The illustrative embodiments are not limited solely to the descriptions and illustrations included herein and are instead capable of various changes and modifications without departing from the spirit of the disclosure.

We claim:

1. A thru-tubing conveyed (TTC) pump system comprising:
a rig-deployed assembly having a motor and a receiving base, the motor configured to turn a first shaft, an end of the first shaft having a non-circular cross-section in a plane perpendicular to a longitudinal axis of the first shaft;
a TTC removable assembly having an engaging base and a pump, the pump configured to be turned by a second shaft, an end of the second shaft having a non-circular cross-section in a plane perpendicular to a longitudinal axis of the second shaft;
wherein the engaging base of the TTC removable assembly engages the receiving base of the rig-deployed assembly when the TTC removable assembly is delivered downhole.

2. The downhole centrifugal pump of claim 1, wherein the end of the first shaft and the end of the second shaft are matingly engaged such that the first shaft and second shaft transmit power from the motor to the pump.

3. The downhole centrifugal pump of claim 2, wherein the engaging base and the receiving base are configured to be de-coupled such that the TTC removable assembly is removed from the well.

4. The downhole centrifugal pump of claim 1, wherein the non-circular cross-section of the coupling members is polygonal.

5. The downhole centrifugal pump of claim 1, wherein the non-circular cross-section of the coupling members further comprises a plurality of lobes.

6. The downhole centrifugal pump of claim 1, wherein the non-circular cross-section of the coupling members further comprises three lobes, each lobe being disposed about 120 degrees from an adjacent lobe.

7. The downhole centrifugal pump of claim 6, wherein the non-circular cross-section of the coupling members further comprises three flats, each flat disposed about 120 degrees from an adjacent flat and positioned between two of the three lobes.

8. The downhole centrifugal pump of claim 7, wherein a first circle that circumscribes the lobes is concentric to a second a circle that circumscribes the flats.

9. The downhole centrifugal pump of claim 1, wherein the non-circular cross-section of the coupling members further comprises four lobes, each lobe being disposed about 90 degrees from an adjacent lobe.

10. A crossover coupling for a thru-tubing conveyed (TTC) pump system comprising:
an engaging base and a first shaft having a longitudinal axis, the first shaft having a first coupling member with a non-circular cross-section in a plane perpendicular to the longitudinal axis; and
a receiving base and a second shaft having a longitudinal axis, the second shaft having a second coupling member with a non-circular cross-section in a plane perpendicular to the longitudinal axis;
wherein the engaging base is configured to be removably coupled to the receiving base.

11. The crossover coupling of claim 10, wherein the first coupling member comprises a female end that engages a male end of the second coupling member to transmit power between the first shaft and the second shaft.

12. The crossover coupling of claim 11, wherein the first shaft is removably coupled to the second shaft.

13. The crossover coupling of claim 10, wherein the non-circular cross-section of the coupling members is polygonal.

14. The crossover coupling of claim 10, wherein the non-circular cross-section of the coupling members further comprises a plurality of lobes.

15. The crossover coupling of claim 10, wherein the non-circular cross-section of the coupling members further comprises three lobes, each lobe being disposed about 120 degrees from an adjacent lobe.

16. The crossover coupling of claim 15, wherein the non-circular cross-section of the coupling members further comprises three flats, each flat disposed about 120 degrees from an adjacent flat and positioned between two of the three lobes.

17. The crossover coupling of claim 16, wherein a first circle that circumscribes the lobes is concentric to a second a circle that circumscribes the flats.

18. The crossover coupling of claim 10, wherein the non-circular cross-section of the coupling members further comprises four lobes, each lobe being disposed about 90 degrees from an adjacent lobe.

19. A method of removing fluid from a wellbore comprising:
within a crossover coupling of a thru-tubing conveyed (TTC) pump system, rotating about a longitudinal axis a first shaft and a second shaft, the first shaft coupled to a motor, the second shaft coupled to a pump;
wherein the first shaft and the second shaft are coupled by mating coupling members, each coupling member having a non-circular cross-section in a plane perpendicular to the longitudinal axis.

20. The method of claim 19 further comprising:
uncoupling the first and second shafts and the mating coupling members while located downhole to allow removal of the pump from the wellbore.
